(19) United States
(12) Patent Application Publication
(10) Pub. No.: US 2008/0015986 A1
(43) Pub. Date: Jan. 17, 2008

(54) Systems, methods and computer program products for controlling online access to an account

(76) Inventor: Robert E. Wright, Marietta, GA (US)

Correspondence Address: MYERS BIGEL SIBLEY & SAJOVEC, P.A., P.O. BOX 37428, RALEIGH, NC, 27627, US

(21) Appl. No.: 11/479,109

(22) Filed: Jun. 30, 2006

(51) Int. Cl. G06Q 40/00

(52) U.S. Cl. 705/44

(57) ABSTRACT

According to embodiments of the present invention, a method for controlling online access by a user of a client to an account of an e-commerce provider, wherein the client, the e-commerce provider and an authentication service provider are interconnected by a computer network, includes: at the e-commerce provider, determining whether a first authentication factor from the user is valid for an identified customer associated with the account; receiving from the authentication service provider a determination as to whether a second authentication factor from the user is valid for the identified customer; permitting access by the user to the account if both of the first and second authentication factors are validated by the e-commerce provider and the authentication service provider, respectively; and denying access by the user to the account if either of the first and second authentication factors are not validated by the e-commerce provider and the authentication service provider, respectively.

### FIELD OF THE INVENTION

The present invention relates generally to computer systems, methods and computer program products and, more particularly, to electronic commerce and authentication conducted via computer networks.

### BACKGROUND OF THE INVENTION

The Internet provides pervasive access to sensitive online information and transactions, including financial account transactions and product ordering transactions. Access to this information must be protected and unauthorized individuals must not be allowed to execute transactions (e.g., issue invalid orders or execute bank account withdrawals). Many online e-commerce providers provide only simple password level protection for such accounts. Some providers provide more sophisticated authentication commonly referred to as multi-factor or two-factor authentication. For example, a provider may require and use a personal identification number (PIN) in combination with a digital certificate or a set of numbers generated by a token to authenticate a user.

### SUMMARY OF THE INVENTION

According to embodiments of the present invention, a method for controlling online access by a user of a client to an account of an e-commerce provider, wherein the client, the e-commerce provider and an authentication service provider are interconnected by a computer network, includes: at the e-commerce provider, determining whether a first authentication factor from the user is valid for an identified customer associated with the account; receiving from the authentication service provider a determination as to whether a second authentication factor from the user is valid for the identified customer; permitting access by the user to the account if both of the first and second authentication factors are validated by the e-commerce provider and the authentication service provider, respectively; and denying access by the user to the account if either of the first and second authentication factors are not validated by the e-commerce provider and the authentication service provider, respectively.

According to some embodiments, the method includes: receiving the first and second authentication factors from the user at the e-commerce provider via the computer network; sending the second authentication factor from the e-commerce provider to the authentication service provider; and receiving a validation report at the e-commerce provider from the authentication service provider, the validation report including the determination as to whether the second authentication factor is valid for the identified customer.

According to some embodiments, the authentication service provider is operated independently of the e-commerce provider.

According to embodiments of the present invention, a system includes an e-commerce provider that maintains an account and is configured to control online access by a user of a client to the account. The e-commerce provider is configured to: at the e-commerce provider, determine whether a first authentication factor from the user is valid for an identified customer associated with the account; receive from an authentication service provider a determination as to whether a second authentication factor from the user is valid for the identified customer; permit access by the user to the account if both of the first and second authentication factors are validated by the e-commerce provider and the authentication service provider, respectively; and deny access by the user to the account if either of the first and second authentication factors are not validated by the e-commerce provider and the authentication service provider, respectively.

According to further embodiments of the present invention, a computer program product for controlling online access by user of a client to an account of an e-commerce provider is provided. The computer program product comprises a computer usable medium having computer usable program code embodied therein. The computer usable program code includes computer usable program code configured to: at the e-commerce provider, determine whether a first authentication factor from the user is valid for an identified customer associated with the account; receive from an authentication service provider a determination as to whether a second authentication factor from the user is valid for the identified customer; permit access by the user to the account if both of the first and second authentication factors are validated by the e-commerce provider and the authentication service provider, respectively; and deny access by the user to the account if either of the first and second authentication factors are not validated by the e-commerce provider and the authentication service provider, respectively.

Further features, advantages and details of the present invention will be appreciated by those of ordinary skill in the art from a reading of the figures and the detailed description of the preferred embodiments that follow, such description being merely illustrative of the present invention.

### BRIEF DESCRIPTION OF THE DRAWINGS

FIG. 1 is a block diagram of a system suitable for use with embodiments of the present invention.

FIG. 2 is a block diagram of data processing systems according to embodiments of the present invention.

FIG. 3 is a more detailed block diagram of data processing systems according to embodiments of the present invention.

FIG. 4 is a flowchart illustrating operations according to embodiments of the present invention.

FIGS. 5A and 5B are, collectively, a flowchart illustrating further operations according to embodiments of the present invention.

### DETAILED DESCRIPTION OF THE EMBODIMENTS OF THE INVENTION

The present invention now will be described more fully with reference to the accompanying drawings, in which embodiments of the invention are shown. However, this invention should not be construed as limited to the embodiments set forth herein. Rather, these embodiments are provided so that this disclosure will be thorough and complete, and will fully convey the scope of the invention to those skilled in the art. Like numbers refer to like elements throughout.

As used herein, the term “comprising” or “comprises” is open-ended, and includes one or more stated features, integers, elements, steps, components or functions but does not preclude the presence or addition of one or more other features, integers, elements, steps, components, functions or groups thereof. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein. Well-known functions or configurations may not be described in detail for brevity and/or clarity.

A communications network with which the present invention may be utilized is the Internet. The Internet is a worldwide decentralized network of computers having the ability to communicate with each other. The Internet has gained broad recognition as a viable medium for communicating and for conducting business. The World-Wide Web (Web) is comprised of server-hosting computers (Web servers) connected to the Internet that have hypertext documents (referred to as Web pages) stored therewithin. Web pages are accessible by client programs (e.g., Web browsers) utilizing the Hypertext Transfer Protocol (HTTP) via a Transmission Control Protocol/Internet Protocol (TCP/IP) connection between a client-hosting device and a server-hosting device, and/or between wireless client/devices and Wireless Application Protocol (WAP) server devices. While HTTP and Web pages are the prevalent forms for the Web, the Web itself refers to a wide range of protocols including Secure Hypertext Transfer Protocol (HTTPS), File Transfer Protocol (FTP), and Gopher, and Web content formats including plain text, HyperText Markup Language (HTML), Extensible Markup Language (XML), Wireless Markup Language (WML), as well as image formats such as Graphics Interchange Format (GIF) and Joint Photographic Experts Group (JPEG).

A Web site is conventionally a related collection of Web files that includes a beginning file called a “home” page. From the home page, a visitor can access other files and applications at a Web site. A large Web site may utilize a number of servers, which may or may not be different and which may or may not be geographically-dispersed. A Web server (also referred to as an HTTP server) is a computer program that utilizes HTTP to serve files that form Web pages to requesting Web clients. Exemplary Web servers include International Business Machines Corporation's family of Lotus Domino® servers, the Apache server (available from apache.org), and Microsoft's Internet Information Server (IIS), available from Microsoft Corporation, Redmond, Wash. A Web client is a requesting program that also utilizes HTTP. A browser is an exemplary Web client for use in requesting Web pages and files from Web servers. A Web server waits for a Web client, such as a browser, to open a connection and to request a specific Web page or application. The Web server then sends a copy of the requested item to the Web client, closes the connection with the Web client, and waits for the next connection.

HTTP allows a browser to request a specific item, which a Web server then returns and the browser renders within a display screen. To ensure that browsers and Web servers can interoperate unambiguously, HTTP defines the exact format of requests (HTTP requests) sent from a browser to a Web server as well as the format of responses (HTTP responses) that a Web server returns to a browser. Exemplary browsers that can be utilized by users accessing a Web site according to the present invention include, but are not limited to, Netscape Navigator® (America Online, Inc., Dulles, Va.) and Internet Explorer™ (Microsoft Corporation, Redmond, Wash.). Browsers typically provide a graphical user interface for retrieving and viewing Web pages, applications, and other resources served by Web servers.

As is known to those skilled in this art, a Web page is conventionally formatted via a standard page description language such as HTML, which typically contains text and can reference graphics, sound, animation, and video data. HTML provides for basic document formatting and allows a Web content provider to specify anchors or hypertext links (typically manifested as highlighted text) to other servers. When a user selects (i.e., activates) a particular hypertext link, a browser running on the user's client device reads and interprets an address, called a Uniform Resource Locator (URL) associated with the hypertext link, connects the browser with a Web server at that address, and makes a request (e.g., an HTTP request) for the file identified in the hypertext link. The Web server then sends the requested file to the client device, which the browser interprets and renders within a display screen.

The present invention may be embodied as methods, systems, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in an object oriented programming language such as Java®, Smalltalk or C++. However, the computer program code for carrying out operations of the present invention may also be written in conventional procedural programming languages, such as the “C” programming language or compiled Basic (CBASIC), or in a functional or interpreted (or fourth generation) programming language such as Lisp, SML, or Forth. Furthermore, some modules or routines may be written in assembly language or even micro-code to enhance performance and/or memory usage. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to an embodiment of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart and/or block diagram block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart and/or block diagram block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart and/or block diagram block or blocks.

Accordingly, steps of the flow chart illustrations and blocks of the block diagrams support combinations of means for performing the specified functions, combinations of steps for performing the specified functions and program instruction means for performing the specified function. It will also be understood that each step of the flow chart illustrations, and combinations of steps in the flow chart illustrations, can be implemented by special purpose hardware based computer systems which perform the specified functions or steps, or combinations of special purpose hardware and computer instructions.

As discussed above, e-commerce providers use passwords or multi-factor (e.g., two-factor) authentication to authenticate the identity of a user online for access to or usage of an account of the e-commerce provider. However, to enable such authentication, the provider maintains the authentication data. For example, the provider may maintain a listing of account numbers and their corresponding passwords and token data. Unfortunately, the provider's data may not be secure. In particular, a malicious insider or an outside party may compromise the provider's data system and misappropriate the authentication data. The misappropriator may thereafter pose as a valid account holder and pass the authentication process of the provider by supplying the misappropriated authentication data.

Embodiments of the present invention can address the above-noted potential weaknesses in an online authentication system. More particularly, embodiments of the present invention can provide an authentication system and protocol that provide the strength of multiple factor authentication and also enhanced protection against improper authentication in the event an e-commerce provider is itself compromised. In accordance with embodiments of the present invention, methods, systems and computer program products are provided for controlling online access to an account of an e-commerce provider by a user. The identity of the user is authenticated using multiple authentication factors supplied by the user, which are validated by multiple respective parties. More particularly, the e-commerce provider authenticates one of the authentication factors and a third party or authentication service provider separately authenticates another of the authentication factors. The authentication service provider may be independent of the e-commerce provider. By providing multiple factor, distributed authentication or validation as described herein, a stronger authentication process may be provided to prevent account access by unauthorized individuals.

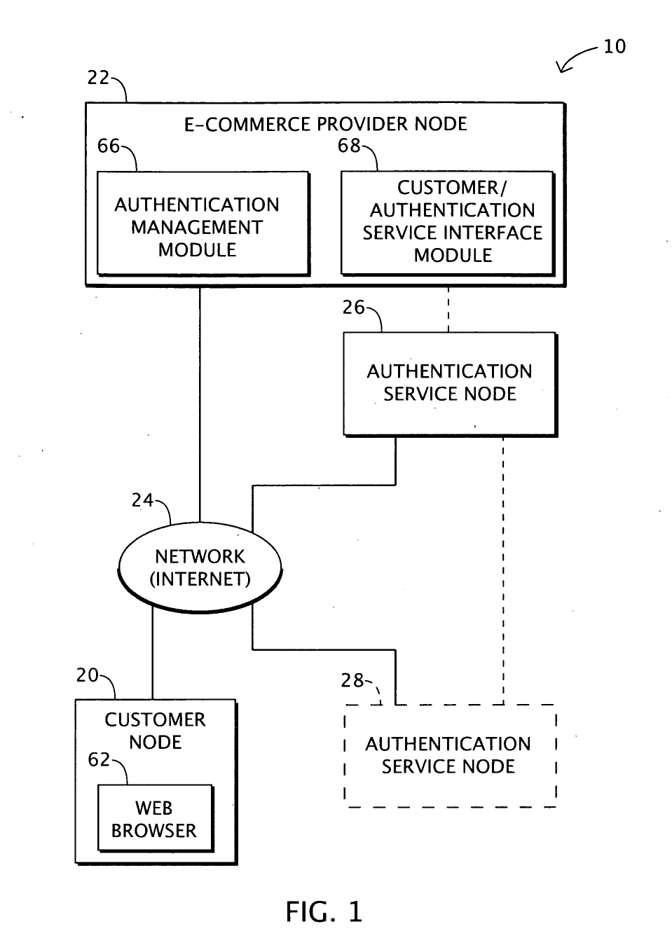

Referring now to FIG. 1, a system 10 suitable for use with various embodiments of the present invention is illustrated. As seen in FIG. 1, a client or customer web client data processing system (or customer node) 20 communicates over a data communication network 24 with an e-commerce provider server (or e-commerce provider node) 22. Alternatively or additionally, the customer node 20 may communicate with the e-commerce node 22 via an alternative link (e.g., a virtual private network). The system 10 further includes an authentication server or node 26 that communicates with the e-commerce node 22 via the network 24 and/or an alternative link (e.g., a virtual private network as indicated by dashed lines in FIG. 1). The system 10 may further include one or more further authentication servers or nodes 28 that communicate with the authentication server or node 26 via the network 24 and/or an alternative link (e.g., a virtual private network as indicated by dashed lines in FIG. 1).

The e-commerce server 22 may provide Web pages, applets or other such programs to the customer node 20 over the network 24. The network 24 may be the Internet or an intranet or a combination of the two and may include various types of communications including communications over telephone lines, wireless communications, local area network (LAN) or wide area network (WAN) communications or the like.

In operation, the e-commerce provider node 22 provides a Web page containing images adapted to instruct and solicit information and instructions from a customer. The customer node 20 displays the Web pages and a user selects options and provides information through selective manipulation of buttons and the like and entry of data into selected fields.

The e-commerce provider node 22 may provide to the customer node 20 browser interpretable pages such as HTML pages, dynamic HTML (DHTML) pages or Extensible Markup Language (XML) pages which may display information for on-line transactions. As will be appreciated by those of skill in the art, the customer node 20 may be any user workstation or device capable of rendering the browser interpretable pages such as, for example, a personal computer or a network computer or even pervasive computing devices such as a personal data assistant (PDA) or a smartphone. Furthermore, the term browser is used herein to refer to any application, program, hardware or other device that may interpret and display a browser interpretable page such as an HTML or XML page. Accordingly, the present invention should not be construed as limited to any particular workstation or browser implementation. Furthermore, the present invention may be applicable to a number of different architectures and, thus, should not be construed as limited to the particular configuration illustrated in FIG. 1, but may be utilized with any configuration suitable for carrying out the operations described herein.

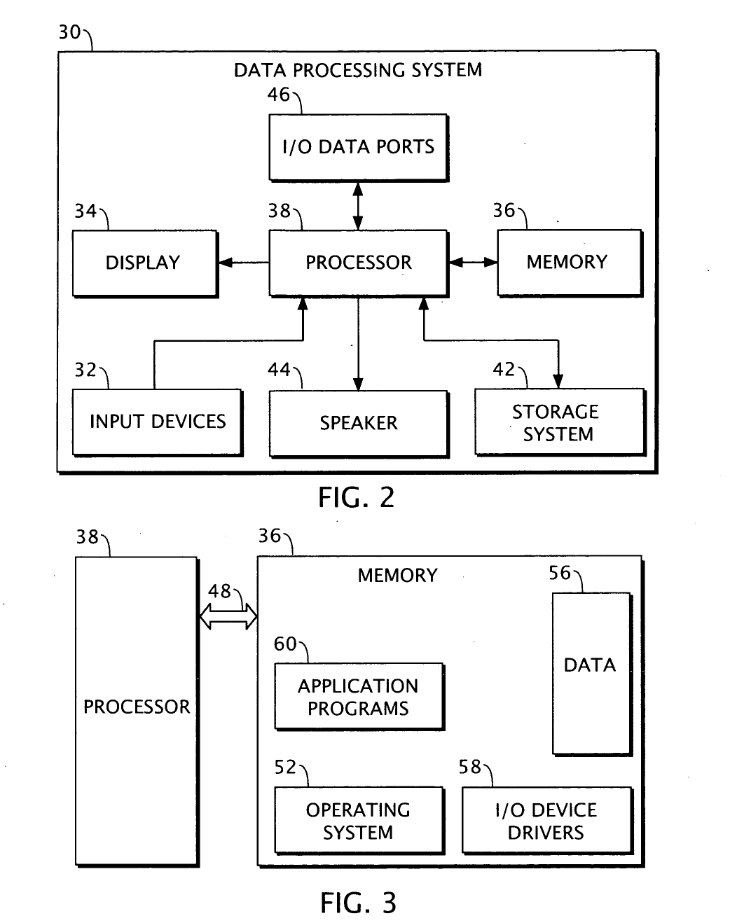

Referring now to FIG. 2, an exemplary embodiment of a data processing system 30 suitable for use as the customer node 20 and/or the e-commerce provider node 22 in accordance with embodiments of the present invention is illustrated and may include input device(s) 32 such as a keyboard or keypad, a display 34, and a memory 36 that communicate with a processor 38. The data processing system 30 may further include a storage system 42, a speaker 44 and an I/O data port(s) 46 that also communicate with the processor 38. The storage system 42 may include removable and/or fixed media such as floppy disks, ZIP drives, hard disks or the like as well as virtual storage such as a RAMDISK. The I/O data port 46 can be used to transfer information between the data processing system 30 and another computer system or a network (e.g., the Internet). Such data processing systems may include, for example, personal computers, laptop computers, mainframe computers, pervasive computing devices such as personal digital assistants, smartphones or the like, or even embedded processing systems. The components of a particular data processing system may be conventional or custom components, such as those used in many conventional computing devices, which may be configured to operate as described herein.

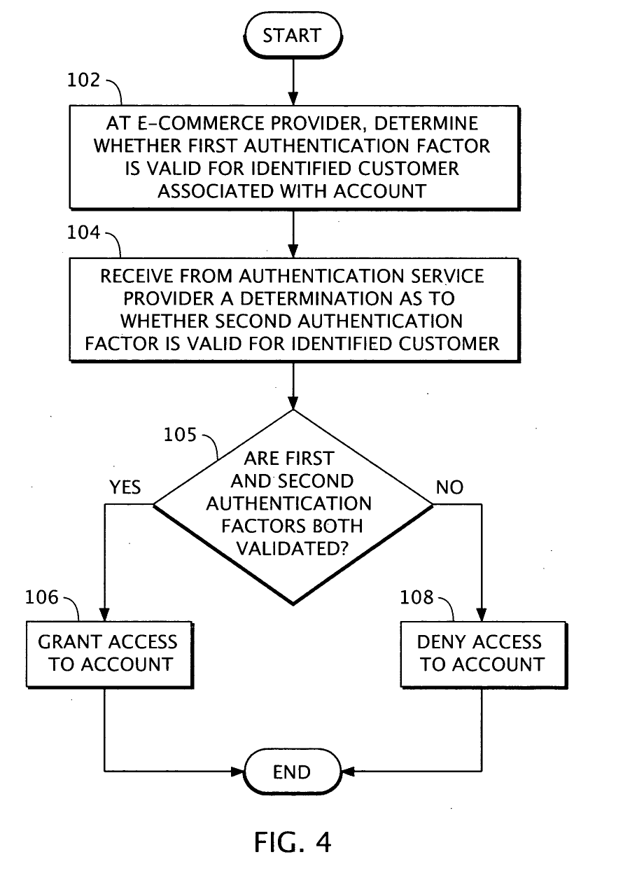

FIG. 3 is a block diagram of data processing systems that illustrate systems, methods, and computer program products in accordance with embodiments of the present invention. The processor 38 communicates with the memory 36 via an address/data bus 48. The processor 38 can be a commercially available or custom microprocessor. The memory 36 is representative of the overall hierarchy of memory devices containing the software and data used to implement the functionality of the data processing system 30. The memory 36 can include, but is not limited to, the following types of devices: cache, ROM, PROM, EPROM, EEPROM, flash memory, SRAM, and DRAM.

As shown in FIG. 3, the memory 36 may contain several categories of software and data used in the data processing system 30: the operating system 52; the application program(s) 60; the input/output (I/O) device drivers 58; and the data 56. As will be appreciated by those of skill in the art, the operating system 52 may be any operating system suitable for use with a data processing system, such as OS/2, AIX or OS/390 from International Business Machines Corporation, Armonk, N.Y., WindowsCE, WindowsXP, WindowsNT, Windows95, Windows98 or Windows2000 from Microsoft Corporation, Redmond, Wash., PalmOS from Palm, Inc., MacOS from Apple Computer, UNIX or Linux, proprietary operating systems or dedicated operating systems, for example, for embedded data processing systems.

The I/O device drivers 58 typically include software routines accessed through the operating system 52 by the application program 60 to communicate with devices such as the input devices 32, the display 34, the speaker 44, the storage system 42, the I/O data port(s) 46, and certain memory 36 components. The application program(s) 60 is illustrative of the programs that implement the various features of the data processing system 30. Finally, the data 56 represents the static and dynamic data used by the application program(s) 60, operating system 52, I/O device drivers 58, and other software programs that may reside in the memory 36.

As is further seen in FIG. 1, the application program(s) 60 of the customer node 20 may include a web browser 62. The web browser 62 may be any conventional web browser capable of being configured to carry out the operations described herein.

As is further seen in FIG. 1, the application program(s) 60 of the e-commerce provider node 22 may include an authentication management module 66 and a customer/authentication service interface module 68. The authentication management module 66 may be used to coordinate and execute the various steps and processes of the e-commerce provider node 22 described herein for authenticating the customer. The customer/authentication service interface module 68 may operate to interface and exchange data with the customer node 20 and the authentication service node 26 as described herein.

The present invention should not be construed as limited to the configuration of FIGS. 1-3, but may encompass any suitable architecture, programming language or division of function that may carry out the operations described herein for facilitating online shopping. While the present invention is illustrated, for example, with reference to a web browser 62, as will be appreciated by those of skill in the art, the functions carried out by these modules may also be incorporated into for example, the operating system 52.

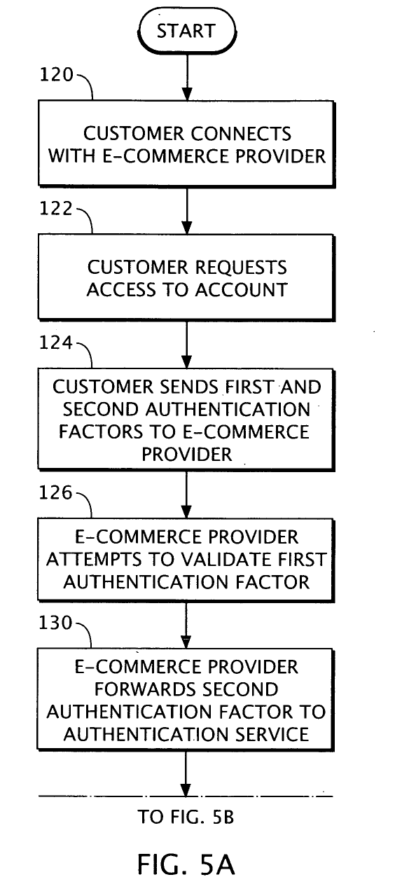

Referring now to FIG. 4, a flow chart illustrating operations of the present invention for authenticating a user will now be described. It will be appreciated that, in accordance with embodiments of the present invention, various of the steps, criteria, etc. disclosed herein may be omitted, modified, reordered, differently combined, etc.

According to embodiments of the present invention, an e-commerce provider determines whether a first authentication factor from a user seeking access to an account of the e-commerce provider is valid for an identified customer associated with the account (Block 102). The e-commerce provider receives from an authentication service provider a determination as to whether a second authentication factor from the user is valid for the identified customer (Block 104). If both of the first and second authentication factors are validated by the e-commerce provider and the authentication service provider, respectively (Block 105), then the user is granted or permitted access to the account (Block 106). If either of the first and second authentication factors are not validated by the e-commerce provider and the authentication service provider, respectively, then the user is denied access to the account (Block 108).

According to some embodiments, the authentication service provider is operated independently of the e-commerce provider. According to some embodiments, the e-commerce provider is capable of requesting and receiving a determination as to whether the second authentication factor is valid, but is not capable of determining or accessing the underlying mechanism or data necessary for validating the second authentication factor. Likewise, according to some embodiments, the authentication service provider is not capable of determining or accessing the underlying mechanism or data necessary for validating the first authentication factor. Thus, a malicious party having control of or access to one of the e-commerce provider and the authentication service provider cannot thereby obtain the information necessary to determine both the first authentication factor and the second authentication factor. By segregating the authentication responsibilities between two independent parties, the risk of granting account access to an unauthorized party can be substantially reduced.

The e-commerce provider may be a merchant or online bank, brokerage or other financial institution, for example. The authentication service provider may be an entity or enterprise the offers the service of authenticating factors, which may include maintaining authentication records as discussed herein as a part or the whole of its business, for example. The identified customer may be the owner of an account maintained by the e-commerce provider. For example, the identified customer may be a bank account owner, a stock brokerage account owner, or a registered customer of a merchant. If granted access to an account, the user may be enabled via the account to issue orders, order products, execute bank account transactions such as withdrawals, etc.

According to some embodiments, each of the foregoing communications between the client and the e-commerce provider are executed via the Internet. According to some embodiments, each of the foregoing communications between the e-commerce provider and the authentication service provider are executed via the Internet.

In general, the e-commerce provider node 26 may reply and send messages to the user by displaying such replies or messages on the display of the customer node 20 and/or via other output devices such as speakers, etc. The user may send replies and messages electronically via the customer node 20. For brevity and clarity, the present disclosure may refer to the customer or user as sending a message or reply to the e-commerce provider node 26 or the e-commerce provider node 26 sending a reply or message to the customer or user, it being understood that such operations and communications are accomplished via the nodes 20, 26 as appropriate.

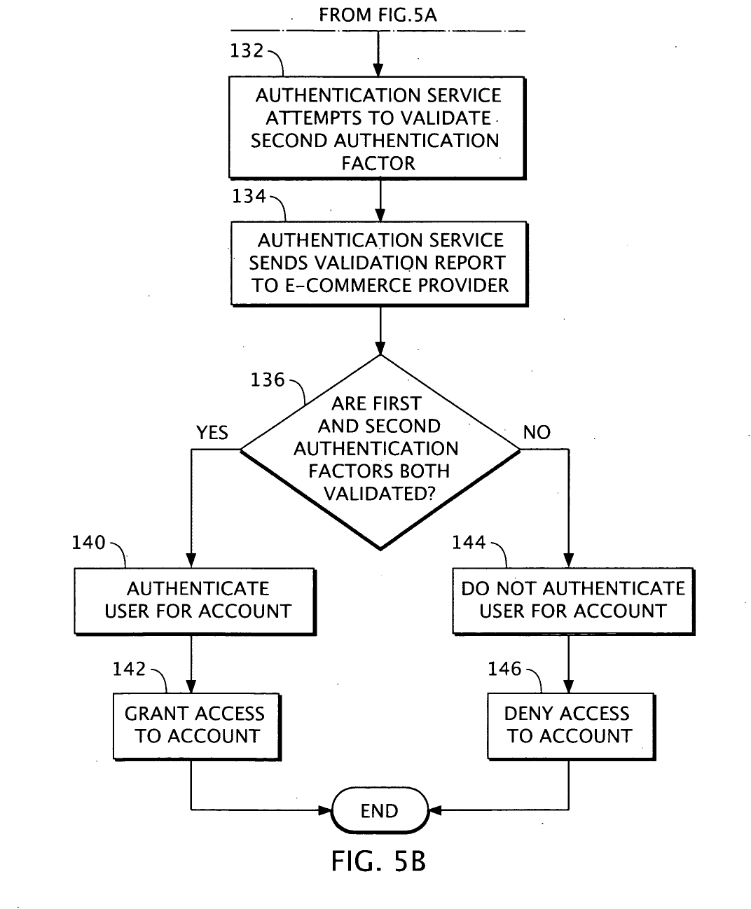

More particular embodiments of the present invention will now be described with reference to the flowchart of FIGS. 5A and 5B. The customer or user using the customer node 20 connects to the e-commerce provider node 22 via the network 24 (Block 120). Upon connecting, the user may be presented by the e-commerce provider node 26 with a suitable welcoming or gateway Webpage interface for soliciting and/or receiving entry of account data.

The customer requests access to and/or control of an account of the e-commerce provider and provides authentication data (Block 122). The user may provide additional data such as an account number, username, etc. The e-commerce provider may request the authentication data in response to a request for account access or the aforementioned gateway Webpage may request the authentication data, for example.

The user sends the user's authentication data via the customer node 20 to the e-commerce provider node 22 (Block 124). The authentication data includes multiple factors. For the purpose of description, the authentication data will be described as including only two authentication factors (a first factor and a second factor). However, three or more authentication factors may be required, provided and processed in accordance with some embodiments of the invention. The discussion of the first and second authentication factors herein likewise applies to such further authentication factors.

The first and second authentication factors may be any suitable types of data. The first and second factors may include authentication factor data of the types otherwise employed for multiple factor authentication (e.g., in prior art multiple factor authentication protocols). The authentication data for either or both of the first and second factors may include: data representing “something you know” (i.e., information the user knows); data representing “something you have” (i.e., information the user possesses); or data representing “something you are” (i.e., a feature of the user).

Examples of “something you know” include: a password (persistent or temporal (e.g., one-time use password or password having expiration date)); a PIN; special knowledge (e.g., mother's maiden name, first car, favorite color, or date of birth).

Examples of “something you have” may include: a digital certificate; token data provided by a token device; Radio Frequency Identification (RFID); or proximity card. For example, the “something you have” factor may be a digital certificate stored on the customer node 20 or an object (e.g., a card or other portable storage device) that is read by the customer node 20 (e.g., using a card reader, USB port, etc.). The “something you have” factor may be a password, passcode or other credential generated by a token or authenticator that displays an authentication code that the user then enters and sends to the e-commerce provider node 22 to demonstrate that the user has possession of the token. The token may be a dedicated token device such as an RSA SecurID™ hardware token. The token may be a software token (e.g., an RSA SecurID™ software token) running on a suitable computing device such as a desktop personal computer, a laptop computer, a smartphone, a handheld PDA, or the like. According to some embodiments, the token periodically generates (and may display) a new password or passcode (commonly referred to as a “one time passcode”) that supercedes prior passwords or passcodes. The generated passcode may be determined according to an algorithm running on an associated authentication server with which the token in synchronized. For example, such a token may generate and display a new passcode every 30 seconds.

Examples of “something you are” may include a biometric credential. The biometric credential may be acquired by user interaction with a hardware device that acquires a biometric reading of the user, which is then forwarded (with or without further processing) by the customer node 20 to the e-commerce provider node 22. The biometric credential may be acquired by any suitable method such as a fingerprint scan, a face scan, a retina scan, or a voice analysis.

The e-commerce provider node 22 determines whether a user account matching the user's request is available on or via the e-commerce provider node 22. If so, the e-commerce provider node 22 identifies the customer associated with the requested account and attempts to validate the first authentication factor from the user for the identified customer (Block 126). That is, the e-commerce provider node 22 attempts to determine whether or confirm that the first authentication factor corresponds with the identified customer.

The e-commerce provider node 22 also forwards the second authentication factor from the user to the authentication service node 26 to be evaluated (Block 130). The authentication service node 26 attempts to validate the second authentication factor from the user for the identified customer (Block 132). The authentication service node 26 compiles and sends a validation report to the e-commerce provider node 22 indicating whether the second authentication factor has been determined by the authentication service node 26 to be valid or invalid (Block 134). The authentication service node 26 may perform the validation itself. The authentication service node 26 may request and receive information from the further authentication service node 28 to facilitate the validation analysis. The authentication service node 26 may issue a validation request to the further authentication service node 28. In the latter case, the authentication service node 28 may perform the validation and issue a validation report to the authentication service node 26. Accordingly, it will be appreciated that the discussion hereinbelow regarding the authentication service node 26 may likewise refer to the further authentication service node 28.

The e-commerce provider node 22 determines whether the first authentication factor has been deemed valid (by the e-commerce provider node 22) for the identified customer and the second authentication factor has been deemed valid (by authentication service node 26) for the identified customer (Block 136). If both authentication factors have been deemed valid, the user's identity is authenticated as the customer or user associated with the requested account (Block 140). The user may then be granted access via the customer node 20 to the account on the e-commerce provider node 22 (Block 142).

If either or both of the authentication factors have been deemed invalid, the user's identity is not authenticated as the customer or user associated with the requested account (Block 144). The user may then be denied access via the customer node 20 to the account on the e-commerce provider node 22 (Block 146). The e-commerce provider node 22 may send a message to the customer node 20 indicating that the account access request has been rejected.

Each of the validation steps may be performed in any suitable manner appropriate for the type of authentication factor being evaluated for validation using records and/or applications operating on the validating server. The e-commerce provider node 22 and the authentication service node 26 (and/or the authentication service node 28) each include data and software as needed to execute their respective validation analyses. Such data and software may include a passcode generator and/or a lookup table.

For example, if the first authentication factor is a PIN or password, the e-commerce provider node 22 compares the first authentication factor to the PIN(s) or password(s) stored in the memory 36 of the e-commerce provider node 22 that are correlated to the account. If a proper match is made, the first authentication factor is validated. By way of further example, if the second authentication factor is a passcode generated by a token, the authentication service node 26 compares the second authentication factor to the corresponding passcode generated by passcode generator software running on the authentication service node 26. Similarly, the second authentication factor may be a PIN or password that is compared to the PIN(s) or password(s) stored in the memory 36 of the authentication service node 26 and the first authentication factor may be a passcode generated by a token that is compared to the corresponding passcode generated by passcode generator software running on the e-commerce provider node 22.

Typically, the user must be suitably pre-registered with each of the e-commerce provider node 22 and the authentication service node 26 (and/or the authentication service node 28) with respect to the corresponding of the authentication factors. For example, if the authentication factor to be validated is a PIN or password, the user must have already been assigned or requested that that PIN or password be associated with the user or account, a record of which is stored or made available to the validating node. If the authentication factor to be validated is a passcode generated by a token, a record of the token and the associated seed or algorithm must be stored on or made available to the validating node.

According to some embodiments, the first authentication factor (which is validated by the e-commerce provider node 22) is a “something you know” or “something you are” factor or credential, and the second authentication factor (which is validated by the authentication service node 26 and/or the authentication service node 28) is a “something you have” factor or credential. According to some embodiments, the second authentication factor is a digital certificate or token that has been pre-registered with the authentication service node 26 (and/or the authentication service node 28).

According to some embodiments, the e-commerce provider node 22 will first attempt to validate the first authentication factor and will then forward the authentication factor to the authentication service node 26 if the first authentication factor is validated. According to some embodiments, the e-commerce provider node 22 will await receipt of a positive validation report from the authentication service node 26 before attempting to validate the first authentication factor. According to some embodiments, the e-commerce provider node 22 will forward the second authentication factor to the authentication service node 26 for validation and proceed with attempting to validate the first authentication factor without awaiting the validation report.

According to some embodiments, the authentication service node 26 may have or retrieve supplemental information associated with the second authentication factor. The authentication service node 26 may send this supplemental information to the e-commerce provider node 22 in the validation report. The supplemental information may include, for example, a registered user name associated with the second authentication factor, corporate affiliation, or organization affiliation.

Many alterations and modifications may be made by those having ordinary skill in the art, given the benefit of present disclosure, without departing from the spirit and scope of the invention. Therefore, it must be understood that the illustrated embodiments have been set forth only for the purposes of example, and that it should not be taken as limiting the invention as defined by the following claims. The following claims, therefore, are to be read to include not only the combination of elements which are literally set forth but all equivalent elements for performing substantially the same function in substantially the same way to obtain substantially the same result. The claims are thus to be understood to include what is specifically illustrated and described above, what is conceptually equivalent, and also what incorporates the essential idea of the invention.

That which is claimed is:

1. A method for controlling online access by a user of a client to an account of an e-commerce provider, wherein the client, the e-commerce provider and an authentication service provider are interconnected by a computer network, the method comprising:
at the e-commerce provider, determining whether a first authentication factor from the user is valid for an identified customer associated with the account;
receiving from the authentication service provider a determination as to whether a second authentication factor from the user is valid for the identified customer;
permitting access by the user to the account if both of the first and second authentication factors are validated by the e-commerce provider and the authentication service provider, respectively; and
denying access by the user to the account if either of the first and second authentication factors are not validated by the e-commerce provider and the authentication service provider, respectively.

2. The method of claim 1 including:
receiving the first and second authentication factors from the user at the e-commerce provider via the computer network;
sending the second authentication factor from the e-commerce provider to the authentication service provider; and
receiving a validation report at the e-commerce provider from the authentication service provider, the validation report including the determination as to whether the second authentication factor is valid for the identified customer.

3. The method of claim 2 wherein the validation report further includes supplemental information associated with the second authentication factor.

4. The method of claim 1 wherein the authentication service provider is operated independently of the e-commerce provider.

5. The method of claim 1 wherein one of the first and second authentication factors is “something you have” and the other of the first and second authentication factors is “something you know” and/or “something you are”.

6. The method of claim 5 wherein the second authentication factor is “something you have” and the first authentication factor is “something you know” and/or “something you are”.

7. The method of claim 6 wherein:
the second authentication factor includes at least one of a digital certificate and token data from a token device; and
the first authentication factor includes at least one of a password, a PIN, and a biometric credential.

8. The method of claim 1 including prompting the user to provide the first and second authentication factors to the e-commerce provider.

9. A system comprising an e-commerce provider that maintains an account and is configured to control online access by a user of a client to the account, wherein the e-commerce provider is configured to:
at the e-commerce provider, determine whether a first authentication factor from the user is valid for an identified customer associated with the account;
receive from an authentication service provider a determination as to whether a second authentication factor from the user is valid for the identified customer;
permit access by the user to the account if both of the first and second authentication factors are validated by the e-commerce provider and the authentication service provider, respectively; and
deny access by the user to the account if either of the first and second authentication factors are not validated by the e-commerce provider and the authentication service provider, respectively.

10. The system of claim 9 wherein the e-commerce provider is configured to:
receive the first and second authentication factors from the user at the e-commerce provider via the computer network;
send the second authentication factor from the e-commerce provider to the authentication service provider; and
receive a validation report at the e-commerce provider from the authentication service provider, the validation report including the determination as to whether the second authentication factor is valid for the identified customer.

11. The system of claim 10 wherein the validation report further includes supplemental information associated with the second authentication factor.

12. The system of claim 9 wherein the authentication service provider is operated independently of the e-commerce provider.

13. The system of claim 9 wherein one of the first and second authentication factors is “something you have” and the other of the first and second authentication factors is “something you know” and/or “something you are”.

14. The system of claim 13 wherein the second authentication factor is “something you have” and the first authentication factor is “something you know” and/or “something you are”.

15. The system of claim 14 wherein:
the second authentication factor includes at least one of a digital certificate and token data from a token device; and
the first authentication factor includes at least one of a password, a PIN, and a biometric credential.

16. The system of claim 9 wherein the e-commerce provider is configured to prompt the user to provide the first and second authentication factors to the e-commerce provider.

17. A computer program product for controlling online access by a user of a client to an account of an e-commerce provider, the computer program product comprising:
a computer usable medium having computer usable program code embodied therein, the computer usable program code comprising:
computer usable program code configured to:
at the e-commerce provider, determine whether a first authentication factor from the user is valid for an identified customer associated with the account;
receive from an authentication service provider a determination as to whether a second authentication factor from the user is valid for the identified customer;
permit access by the user to the account if both of the first and second authentication factors are validated by the e-commerce provider and the authentication service provider, respectively; and
deny access by the user to the account if either of the first and second authentication factors are not validated by the e-commerce provider and the authentication service provider, respectively.

18. The computer program product of claim 17 including the computer usable program code configured to:
receive the first and second authentication factors from the user at the e-commerce provider via the computer network;
send the second authentication factor from the e-commerce provider to the authentication service provider; and
receive a validation report at the e-commerce provider from the authentication service provider, the validation report including the determination as to whether the second authentication factor is valid for the identified customer.

19. The computer program product of claim 17 wherein the authentication service provider is operated independently of the e-commerce provider.
